(19) United States
(12) Patent Application Publication
(10) Pub. No.: US 2011/0187542 A1
(43) Pub. Date: Aug. 4, 2011

(54) RADIO FREQUENCY NOTIFICATION SYSTEM AND METHOD

(76) Inventors: William J. DITTMER, Kitchener (CA); Allan DITTMER, Kitchener (CA)

(21) Appl. No.: 13/020,278

(22) Filed: Feb. 3, 2011

Related U.S. Application Data
(60) Provisional application No. 61/300,899, filed on Feb. 3, 2010.

(51) Int. Cl. G08B 17/10; H01H 47/22

(52) U.S. Cl. 340/628; 340/632; 361/170

(57) ABSTRACT

A notification system including an electrical switch wherein the switch includes a radio frequency receiver circuit coupled to a power supply and the RF receiver circuit, in response to an alarm signal, engages an output relay to close at least one electrical contact in the switch. A notification method comprising: a smoke detector emitting an RF alarm signal; an RF receiver circuit in an electrical switch receiving the signal; the RF receiver engaging an output relay; and the output relay closes at least one electrical contract in the switch.

### RELATED APPLICATIONS

This patent application claims the benefit of U.S. Provisional Patent Application No. 61/300,899 filed Feb. 3, 2010, which is hereby incorporated by reference.

### FIELD

The present document relates generally to a warning system. More particularly, the present document relates to a radio frequency (RF) notification system and method.

### BACKGROUND

Detectors such as smoke detectors and carbon monoxide detectors are designed to provide advanced warning in the event of emergencies, such as a fire, and are generally mounted in various locations around residences and buildings. As smoke may not penetrate all areas of a building, smoke detectors may need to be located in numerous locations for adequate coverage to alert an emergency scenario. Generally, when detectors identify an emergency, such as a level of smoke or carbon monoxide above a threshold level, an audible alarm is activated.

Conventional detectors often act as a standalone system. If an alarm sounds at night the occupants of the house may have to struggle to find an exit within the residence or escape route or may not hear the alarm if it is in another remote location.

### SUMMARY

There is a need for electrical switches that can be used with electrical outlets and light fixtures to be equipped for use with radio-frequency (RF) technology. Having electrical switches equipped with RF capabilities allow the switches to receive an alarm or signal from a similarly RF equipped detector. When an alarm or signal is received, the RF equipped electrical switch may activate an internal switch and illuminate an exit or escape route. With the addition of lighting, occupants may not only be able to determine an exit but may also ascertain the amount and location of the smoke and/or fire. With this information the occupants may better understand their situation and better plan for evacuation. There is a further need to integrate an RF notification or alarm system into other electronic devices.

In one aspect, a notification system is provided comprising an electrical switch wherein the switch includes a radio frequency receiver circuit coupled to a power supply and the RF receiver circuit, in response to an alarm signal, engages an output relay to activates at least one electrical contact in the switch or to deactivate the power supply to the switch.

In a further embodiment, a notification method is provide comprising: an electronic device emitting an RF alarm signal; an RF receiver circuit in an electrical switch receiving the signal; the RF receiver engaging an output relay; and the output relay closing at least one electrical contract in the switch or deactivating the power supply to the switch.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Embodiments of the present invention will now be described, by way of example only, with reference to the attached Figures, wherein:

FIG. 1 illustrates a room in a building equipped with the notification system according to one embodiment;

FIG. 2 illustrates an electrical switch circuit according to one embodiment;

FIG. 3 illustrates an electrical switch circuit according to another embodiment; and

FIG. 4 illustrates a flow chart of the notification method according to one embodiment of the present invention.

### DETAILED DESCRIPTION

In order to enhance the effectiveness of detectors, such as smoke or carbon monoxide detectors, the detectors may be outfitted with radio-frequency (RF) capabilities that allow the detectors within a specific area to relay a signal to other RF equipped detectors. For example, with multiple smoke detectors all emitting an audible alarm, it is more likely that occupants will hear and respond to the alarm and less likely that a remote alarm will go undetected.

A radio frequency equipped notification system and method are described below. The notification system, which may be a warning system, has at least one radio-frequency (RF) equipped electrical switch. The RF electrical switch may be designed to activate lighting or deactivate or close at least one electrical contact in the event of detecting a warning or an alarm from an RF equipped detector or when detecting an emergency situation. The electrical switch may include an RF receiver circuit with the ability to detect signals from, for example, an RF enabled smoke detector, carbon monoxide detector, or gas leak detector.

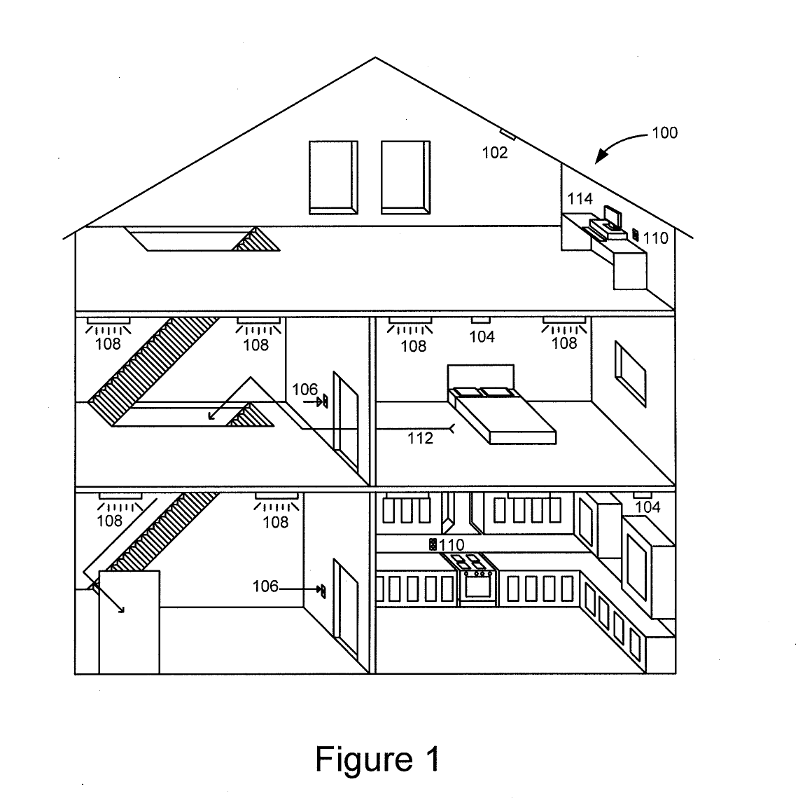

FIG. 1 illustrates a building equipped with notification system, and in particular FIG. 1 illustrates an embodiment of a warning system (100). The warning system has at least one RF enabled detector equipped, which may be, for example, an RF enabled smoke detector (102), carbon monoxide detector or natural gas detector or the like. In a particular example, the RF enabled smoke detector (102) will begin to sound an alarm when an emergency scenario is sensed, such as the level of smoke or temperature above an expected threshold. The smoke detector (102) further emits an RF alarm signal that is received by at least one other component of the warning system, for example, other RF equipped detectors (104), RF equipped electrical light switches (106) or RF equipped electrical sockets (110). When the at least one RF equipped component, for example a light switch (106), receives the RF alarm signal, the light switch (106) may activate thereby illuminating the associated light fixture (108). The light fixtures (108) may illuminate an exit route (112), providing occupants with a clear visual of a possible route out of the room and building. Further, RF equipped electrical sockets (110) may cut power to an attached peripheral, such as a computer (114) currently plugged into the outlet in an attempt to reduce damage experienced by that product during the emergency. The RF equipped sockets (110) may also provide power to turn on lights, such as lamps, which may be plugged into the socket (110).

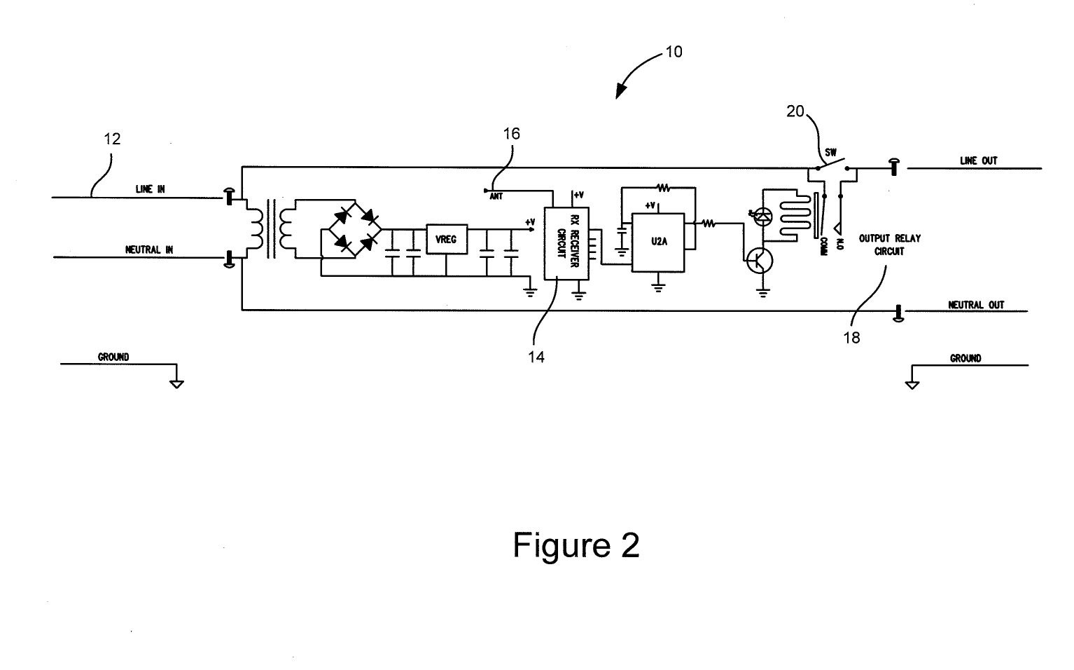

FIG. 2 illustrates an electrical switch (10) for use in one of the switches or sockets of the warning system described in FIG. 1 or in a notification system. The switch (10) may be adapted to engage a previously installed housing attached to a power supply (12), which may be an alternating current (AC) to direct current (DC) power supply. The circuit may convert the AC to low voltage DC to provide power to an RF receiver circuit (14) located within the electrical switch. The RF receiver circuit (14) may include an antenna (16), or other RF sensor, configured to receive signals from an RF enabled detector. The RF receiver circuit (14) is further connected to an output relay (18). The output relay (18) controls at least one electrical contact (20). The output relay (18) may latch an external power source, closing the circuit of the switch. For example, for switches the output relay (18) may turn the power on and activate lights, while for electrical sockets and gas valves, the output relay (18) may deactivate the power circuit. The receiver controls the output relay, once the alarm or RF signal is detected, the receiver circuit triggers the output relay to activate and either engage or disengage at least one electrical contact.

In one embodiment, closing or opening the electrical contacts (20) of the switch (10) may activate a corresponding light fixture or lamp to assist in illuminating an exit or escape route. Illuminating an escape route may provide occupants a safe exit during a fire or other emergency. In this embodiment, the external power source may be a 120V source.

In another embodiment, closing the electrical contacts (20) of the switch (10) may deactivate a power outlet. In the event of an alarm, the power to the plugged in product may be terminated in an attempt to reduce the possible damage to the product or other negative consequences. This embodiment is designed to shut down power to sensitive equipment in the event of a fire or other emergency. For example, an RF equipped electrical outlet may shut down the power to a computer. In the event that the computer is sprayed with water or a fire extinguisher, the electronics may suffer less damage and the data may still be recoverable. The external power source may be 120 V for a generic outlet or may be 220V or 240V power receptacle designed to be used on other appliances, such as stoves or laundry dryers, which may also benefit from having the power deactivated in the case of the RF alarm being activated.

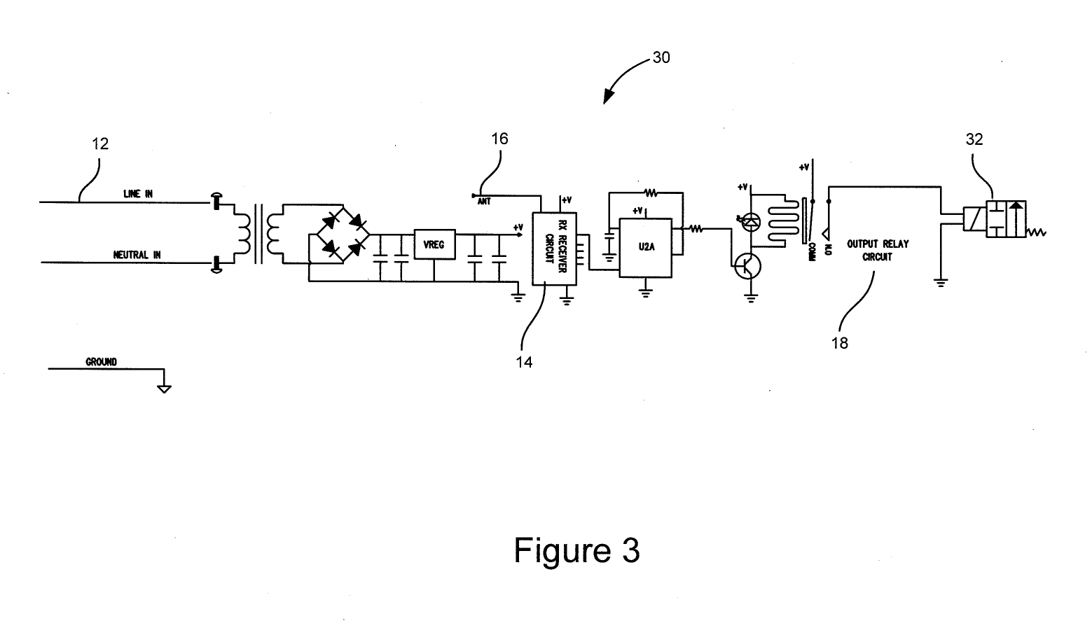

In yet another embodiment, as shown in FIG. 3, an RF enabled switch (30) may be a natural gas switch, which may be used to deactivate the gas once the alarm from the RF enabled detector is detected. This switch may be installed to be used with natural gas appliances, for example, gas stoves, furnaces, water heaters, or the switch may be installed at the main inlet of the natural gas to the building. As with the switch (10), the RF enabled switch (30) includes a power supply (12), an RF receiver circuit (14) and an RF antenna (16). The RF antenna will receive or detect a signal from an RF enabled detector. The RF receiver circuit (14) is further connected to an output relay (18), which controls at least one electrical contact (32). The at least one electrical contact, when activated by the output relay will deactivate the power circuit, and disengage the gas connection. If the building is equipped with a gas leak detector, it is intended that not only will the leak be detected but, if installed at the main inlet of the gas, once the detector initiates an alarm the gas supply may be cut and shut off as well.

Preferably, these switches may be pre-configured or manufactured to detect the RF alarm signal from various RF enabled detectors. The RF equipped electrical switch may then replace a current light switch or power outlet. These switches may be retrofitted and may not require re-wiring of the building or residence.

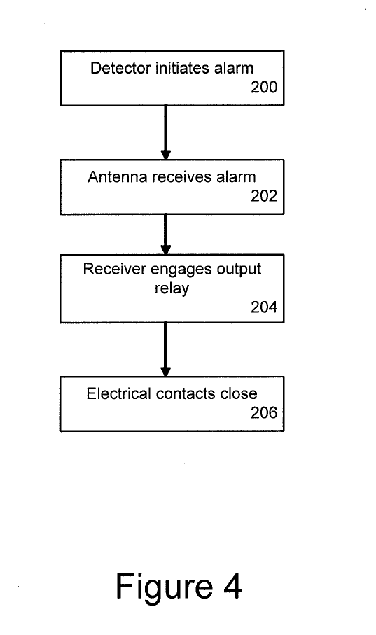

FIG. 4 illustrates the notification method according to one embodiment. Once the RF enabled detector (102) detects an emergency, such as an amount of smoke or carbon monoxide above a predetermined threshold, the detector (102) initiates (200) an alarm signal. The alarm may include both an audible alarm as well as an RF signal to notify other RF components such as RF equipped detectors (104) and the RF equipped light switches (106) and electrical sockets (110) of the alarm. The RF equipped electrical switch (10, 30) incorporated into the light switches (106) and sockets (110) includes the RF receiver circuit (14) with the antenna (16) that is capable of receiving (202) or sensing the RF signal produced by the detector (102). The RF receiver circuit then engages (204) the output relay (18), which closes (206) the switches' electrical contacts (20, 32), activating or deactivating the switch, depending on the pre-configured response. Once the receiver circuit detects a signal it outputs a transistor-to-transistor logic (TTL) signal (high/low) which is relayed to the output relay.

Activating or deactivating the switch (10, 30) may either illuminate the corresponding light or deactivate the corresponding power outlet depending on which of the above embodiments is being employed.

In an alternative embodiment, the notification system may be integrated with an alarm clock or other device as opposed to an RF enabled detector. In this embodiment the device, for example the alarm clock, incorporates RF capabilities and initiates an alarm or notification. On initiation of the notification or the alarm, the alarm clock also emits an RF signal that may be received by an antenna of an RF receiver circuit of an RF equipped electrical switch. The RF equipped electrical switch may be a light switch. On receipt of the RF signal, the RF receiver circuit may relay the information to an output relay, which may close the circuit, thus illuminating the lights. Employing the notification system in this manner is intended to help individuals wake up more quickly by having an alarm that incorporates both light and sound. To achieve this result, a processor (not shown) would be added to the alarm clock or other device. In one particular example, once the receiver circuit detects a signal or alarm, the receiver circuit would activate the processor, which would signal that receiver circuit to have the output relay turn open and close the at least one electrical contact, which may result in flashing the lights until the light switch was physically turned on. The act of turning on the lights resets the processor and the notification system. Other outlets may also be activated, such as activating power to a coffee machine or computer.

According to this alternative embodiment of the notification system, the associated method may be very similar to that shown in FIG. 4. The alarm clock or other device initiates the alarm and may do so on a regular interval, for example: a daily alarm, or may initiate the alarm in response to user input or a certain occurrence. Once the alarm is initiated, an RF signal may also be initiated. An RF equipped electrical switch or outlet, with an RF receiver circuit including an antenna, may detect this RF signal. On detection of the RF signal, the RF receiver circuit may engage the output relay to either close the electrical contacts activating the switch to either turn on lights, to boot up a computer, activate a coffee machine so that when the user wakes up, certain tasks have already been completed.

Further applications are contemplated. Other electronic devices may have RF capabilities that could trigger the RF equipped electrical switch. The notification system should not be considered limited to a smoke detection system and may be used by a device that may incorporate or be retrofitted to allow for the sending of an RF signal. This signal may be received and by an RF equipped electrical switch that may be preprogrammed to perform predetermined functionality such as illuminating a light fixture or activating a product currently plugged into an RF equipped electrical outlet. The RF equipped electrical switch, on receipt of the RF alarm signal, may also de-active the power socket.

Replacing existing electrical switches in bedrooms, stairs and/or hallways with the RF equipped electrical switch provides for an illuminated exit path during a fire or other emergency. The RF equipped electrical switch may detect the alarm signal from an RF equipped smoke detector and automatically activate the associated light to illuminate a pre-determined exit route. By automatically illuminating the exit route, there is a reduced need for individuals to fumble around in the dark or in the smoke to find the light switch and turn on the lights. The RF equipped electrical switches may further provide for a visual and not only audible alarm for the hearing impaired.

In the preceding description, for purposes of explanation, numerous details are set forth in order to provide a thorough understanding of the embodiments. However, it will be apparent to one skilled in the art that these specific details are not required in order to practice the embodiments. In other instances, well-known electrical structures and circuits are shown in block diagram form in order not to obscure the invention.

The above-described embodiments are intended to be examples only. Those of skill in the art can effect alterations, modifications and variations to the particular embodiments without departing from the scope, which is defined solely by the claims appended hereto.

What is claimed is:

1. A radio frequency electrical switch comprising:
a radio frequency (RF) receiver circuit coupled to a power supply and configured to detect an alarm signal; and
an output relay engaged by the RF receiver circuit when the RF receiver circuit detects an alarm and configured to activate at least one electrical contact in the electrical switch once engaged.

2. The electrical switch of claim 1 further comprising an antenna to detect the alarm signal.

3. The electrical switch of claim 1 wherein activating at least one electrical contact activates a light operatively connected with the electrical switch.

4. The electrical switch of claim 1 wherein activating at least one electrical contact deactivates power being drawn from the electrical switch.

5. The electrical switch of claim 1 wherein activating at least one electrical contact activates a device currently attached to the electrical switch.

6. The electrical switch of claim 1 wherein the electrical switch is adapted to be used with a natural gas switch and activating the at least one electrical contact deactivates the gas being drawn by the gas switch.

7. A notification system comprising:
a radio frequency (RF) enabled detector configured to produce an alarm signal; and
at least one radio frequency enable component having a radio frequency enabled electrical switch wherein the electrical switch comprises:
a radio frequency receiver circuit coupled to a power supply and the radio frequency receiver circuit, in response to the alarm signal, engages an output relay to close at least one electrical contact in the switch.

8. The notification system of claim 7 wherein the detector is an RF enabled smoke detector.

9. The notification system of claim 7 wherein the detector is an RF enabled alarm clock.

10. The notification system of claim 7 wherein the detector is an RF enabled carbon monoxide detector.

11. The notification system of claim 7 wherein closing at least one electrical contact activates a light operatively connected with the electrical switch

12. The notification system of claim 7 wherein closing at least one electrical contact deactivates power being drawn from the electrical switch.

13. The notification system of claim 7 wherein the electrical switch is adapted to be used with a natural gas switch and activating the at least one electrical contact deactivates the gas being drawn by the gas switch.

14. The notification system of claim 7 wherein activating at least one electrical contact activates a device currently attached to the electrical switch.

15. A notification method comprising:
detecting the initiation of an alarm through a radio frequency (RF) receiver circuitry of a radio frequency enabled electrical switch;
engaging an output relay on receipt of the alarm via the radio frequency receiver circuitry; and
closing at least one electrical contacts operatively connect to the output relay.

16. The notification method of claim 15 wherein closing at least one electrical contact activates a light operatively connected with the electrical switch

17. The notification method of claim 15 wherein closing at least one electrical contact deactivates power being drawn from the electrical switch.

18. The notification method of claim 15 wherein the alarm is produced by an RF enabled smoke detector.

19. The notification method of claim 15 wherein detecting the initiation of the alarm is detected through an RF enabled antenna operatively connected to the receiver circuitry.

20. The notification method of claim 15 wherein activating at least one electrical contact activates a device currently attached to the electrical switch.
